(19) United States
(12) Patent Application Publication
(10) Pub. No.: US 2025/0391877 A1
(43) Pub. Date: Dec. 25, 2025

(54) POSITIVE ELECTRODE PLATE AND BATTERY

(71) Applicant: ZHUHAI COSMX POWER BATTERY CO., LTD., Zhuhai (CN)

(72) Inventors: Di WANG, Zhuhai (CN); Yingju QIN, Zhuhai (CN); Jianglong HE, Zhuhai (CN)

(73) Assignee: ZHUHAI COSMX POWER BATTERY CO., LTD., Zhuhai (CN)

(21) Appl. No.: 19/227,113

(22) Filed: Jun. 3, 2025

(30) Foreign Application Priority Data
Jun. 25, 2024 (CN) 202410829240.6

(51) Int. Cl. H01M 4/62; H01M 4/02; H01M 4/133; H01M 4/136; H01M 4/58; H01M 4/587; H01M 10/0525

(52) U.S. Cl. CPC H01M 4/625; H01M 4/133; H01M 4/136; H01M 4/5825; H01M 4/587; H01M 4/622; H01M 2004/021; H01M 2004/027; H01M 2004/028; H01M 10/0525

(57) ABSTRACT

Disclosed are a positive electrode plate and a battery. The positive electrode plate includes a positive active material and a conductive agent; the positive active material includes lithium iron phosphate; in the positive electrode plate, within a unit area of 1 μm×1 μm, a ratio of a number of lithium iron phosphate to a number of the conductive agent is 1:(0.5-50). When adjusting the ratio of the number of lithium iron phosphate to the number of conductive agent in the positive electrode plate within the specific range of 1:(0.5-50), it helps form a good conductive network, reduces an internal resistance of the lithium-ion battery, improves a cycle performance and capacity retention rate of the battery, and further enhances a low-temperature cold start performance of the battery.

### CROSS-REFERENCE TO RELATED APPLICATIONS

The present disclosure claims priority to Chinese Patent Application No. 202410829240.6, filed on Jun. 25, 2024, which is hereby incorporated by reference in its entirety.

### TECHNICAL FIELD

The present disclosure relates to a field of lithium-ion battery technology, and in particular to a positive electrode plate and a battery.

### BACKGROUND

With the development of technology, lithium-ion batteries have been widely used in various electronic devices and electric vehicles because of their advantages of high energy density, long cycle life, and environmental protection. Among them, lithium iron phosphate, as a commonly used positive electrode material for lithium-ion batteries, has received widespread attention because of its characteristics of high safety, low cost, and environmental friendliness. However, lithium iron phosphate has a low electronic conductivity, which limits its application in lithium-ion batteries.

### SUMMARY

Objectives of the present disclosure are to overcome the above-mentioned problems existing in conventional technology, and to provide a positive electrode plate and a battery. By adjusting a ratio of a number of lithium iron phosphate to a number of conductive agent in the positive electrode plate within a specific range, it helps to form a good conductive network, reduce the internal resistance of the lithium-ion battery, and improve cycle performance and capacity retention rate of the battery.

Furthermore, by adjusting the ratio of the number of lithium iron phosphate to the number of conductive agent in the positive electrode plate within a specific range, it helps to improve the low-temperature cold start performance of the battery.

To achieve the above objectives, a first aspect of the present disclosure provides a positive electrode plate, where the positive electrode plate includes a positive active material and a conductive agent; the positive active material includes lithium iron phosphate; in the positive electrode plate, within a unit area of 1 μm×1 μm, a ratio of a number of lithium iron phosphate to a number of conductive agent is 1:(0.5-50).

A second aspect of the present disclosure provides a battery, where the battery includes the positive electrode plate according to the first aspect of the present disclosure.

The present disclosure has the following beneficial effects by adopting the above-mentioned technical solution.

Firstly, the positive electrode plate provided by the present disclosure can enhance a ionic conductivity of a battery system, reduce battery ion polarization, effectively improve a terminal voltage of the battery during low-temperature and high-rate discharge, and improve cold start performance.

Secondly, the positive electrode plate provided by the present disclosure can form a good conductive network, which helps to improve charge transfer efficiency, enhance the capacity performance of the battery, and achieve an improvement in the cycle performance of lithium ion.

Lastly, the battery provided by the present disclosure has a low internal resistance, reducing capacity loss, and improving capacity retention rate.

Herein, endpoints of ranges are disclosed and any values are not limited to precise ranges or values, and these ranges or values should be understood to include values close to them. For numerical ranges, between endpoint values of various ranges, between endpoint values of various ranges and individual point values, and between individual point values may be combined with each other to obtain one or more new numerical ranges, which should be regarded as specifically disclosed in this herein. In this herein, unless otherwise specified, data ranges all include endpoints.

### BRIEF DESCRIPTION OF THE DRAWINGS

FIG. 1 shows a surface scanning electron microscope (SEM) image of a positive electrode plate after rolling in Example 1-1 at 30,000× magnification.

FIG. 2 shows a surface SEM image of a positive electrode plate after rolling in Example 1-1 at 20,000× magnification.

FIG. 3 shows a surface SEM image of a positive electrode plate after rolling in Example 1-1 at 10,000× magnification.

FIG. 4 shows a surface SEM image of a positive electrode plate after rolling in Example 1-3 at 30,000× magnification.

FIG. 5 shows a surface SEM image of a positive electrode plate after rolling in Example 1-3 at 20,000× magnification.

FIG. 6 shows a surface SEM image of a positive electrode plate after rolling in Example 1-3 at 10,000× magnification.

### DETAILED DESCRIPTIONS OF THE EMBODIMENTS

Implementations of the present disclosure are described in detail below. It should be understood that the implementations described herein are intended for illustration and explanation only and are not intended to limit the present disclosure.

Unless otherwise defined, all scientific and technical terms used in the present disclosure have the same meaning as commonly understood by those skilled in conventional technology.

A first aspect of the present disclosure provides a positive electrode plate, where the positive electrode plate includes a positive active material and a conductive agent; the positive active material includes lithium iron phosphate; in the positive electrode plate, within a unit area of 1 μm×1 μm, a ratio of a number of lithium iron phosphate to a number of conductive agent is 1:(0.5-50).

A method for counting the number of lithium iron phosphate and conductive agent in the positive electrode plate includes: selecting multiple unit areas of 1 μm×1 μm in an SEM image of the positive electrode plate, respectively counting the number of lithium iron phosphate and conductive agent in each unit area, recording and calculating the ratio of the two, and taking an average value; or, respectively counting the number of a conductive agent around a single lithium iron phosphate particle in each unit area, recording and calculating the ratio of the two, and taking an average value.

The present disclosure finds through research that when the ratio of the number of lithium iron phosphate to the number of conductive agent in the positive electrode plate is controlled within the above-mentioned range, it can adjust the distribution of the conductive agent (such as conductive carbon black) near the lithium iron phosphate particle, help form a good conductive network in the positive electrode plate, reduce the interfacial contact impedance and charge-transfer impedance of the lithium-ion battery, and reduce the internal resistance of the lithium-ion battery, improve charge transfer efficiency, enhance capacity utilization of the battery, and achieve an improvement in a cycle performance of lithium-ion.

The present disclosure also finds through research that at low temperatures, the viscosity of the electrolyte in the battery increases, the diffusion rate of lithium ions decreases, and the internal resistance of the battery increases significantly. When the ratio of the number of lithium iron phosphate to the number of conductive agent in the positive electrode plate is controlled within the above-mentioned range, on the one hand, the porous structure and high specific surface area of the conductive agent can adsorb the electrolyte solution, forming more lithium-ion transport channels and promoting lithium ion diffusibility. On the other hand, the conductive network makes the distribution of Li more uniform within the electrode, avoiding polarization caused by excessive local concentration gradients, reducing battery polarization, and further comprehensively enhancing the low-temperature cold start performance of the battery.

In some embodiments, in the positive electrode plate, within a unit area of 1 μm×1 μm, the ratio of the number of lithium iron phosphate to the number of the conductive agent can be, for example, 1:0.5, 1:2, 1:5, 1:10, 1:15, 1:20, 1:25, 1:30, 1:35, 1:40, 1:45, or 1:50, or any range composed of any two of the aforementioned values and any point value within that range. When the ratio of the number of lithium iron phosphate to the number of conductive agent is less than 1:50, the amount of conductive agent is excessive, and excessive conductive agent agglomerate together, resulting in uneven dispersion of the conductive network inside the electrode, weakening charge transfer efficiency, and reducing cycle performance of the battery. However when the ratio of the number of lithium iron phosphate to the number of conductive agent is greater than 1:0.5, the amount of conductive agent is insufficient, and excessive lithium iron phosphate causes difficulties in charge transfer, making charge unable to be fully stored and released, thereby reducing discharge capacity and weakening the cycle performance of the battery; Meanwhile, it causes the lithium-ion diffusion to be worse, increasing the internal resistance of the lithium-ion battery, which not only increases capacity loss and reduces capacity retention rate, but also increases battery polarization and then deteriorates the low-temperature cold start performance of the battery.

Preferably, the ratio of the number of lithium iron phosphate to the number of conductive agent is 1:(5-40). Further optimizing the ratio of the number of lithium iron phosphate to the number of conductive agent can further improve the cycle performance of the battery, reduce capacity loss, and enhance the low-temperature cold start performance of the battery.

In some embodiments, a mass proportion of the positive active material in the positive electrode plate is 90%-95%, for example, the mass proportion can be 90%, 91%, 92%, 93%, 94%, or 95%, or any range composed of any two of the aforementioned values and any point value within that range. When the mass proportion of the positive active material is within the above range, the battery can store more energy, improve the energy density of the battery, and enhance the cycle life of the battery.

In some embodiments, a mass proportion of the conductive agent in the positive electrode plate is 2%-5%, for example, which can be 2%, 2.5%, 3%, 3.5%, 4%, 4.5%, or 5%, or any range composed of any two of the aforementioned values and any point value within that range. When the mass proportion of the conductive agent is within the above range, it can prevent agglomeration caused by excessive addition of the conductive agent, thereby avoiding impaired charge transfer efficiency and cycle performance. Simultaneously, it can also avoid high internal resistance of the battery due to insufficient addition of the conductive agent, which leads to poor lithium ion diffusivity and thereby affects the capacity retention rate of the battery.

In some embodiments, a primary particle size of the lithium iron phosphate is denoted as A nm, an average particle size of the conductive agent is denoted as B nm, and a ratio of A to B is (2-60):1, for example, which can be 2:1, 3:1, 4:1, 5:1, 8:1, 10:1, 15:1, 20:1, 30:1, 40:1, 50:1, or 60:1, or any range composed of any two of the aforementioned values and any point value within that range. Lithium iron phosphate is a secondary particle formed by an aggregation of multiple primary particles with a smaller average particle size. The “primary particle size” of lithium iron phosphate refers to the average particle size of the primary particles in the secondary particle of lithium iron phosphate.

In the present disclosure, the “average particle size” refers to a numerical average particle size, which means an average value of all primary particle sizes (the size can refer to the diameter of the primary particles). For example, in an electron micrograph, the morphology and size of the conductive agent particles are observed through an electron microscope, and then image analysis software is used to measure the conductive agent particles and calculate the numerical average particle size.

When the ratio of the primary particle size of lithium iron phosphate to the average particle size of the conductive agent is less than 2:1, the primary particle size of lithium iron phosphate is too small, making the particles prone to aggregation. Meanwhile, as the number of contact points between lithium-iron phosphate particles increases, hindering electron transfer and thus increasing the internal resistance. The increase in internal resistance makes the migration and intercalation of lithium ions more difficult, and the resulting polarization seriously affects the low-temperature cold start performance. The energy loss caused by the internal resistance during the charging and discharging process of the lithium-ion battery directly leads to a rise in the internal temperature of the lithium-ion battery, weakening the structural and chemical stability of the lithium-ion battery materials, and significantly reducing the cycle life and storage performance of the battery. However, when the ratio of the primary particle size of lithium iron phosphate to the particle size of the conductive agent is greater than 60:1, the primary particle size of lithium iron phosphate is too large, and the lithium ion diffusion path becomes longer. Because lithium ions produce higher concentration polarization when diffusing on the surface and inside larger primary particles, while lower concentration polarization occurs during diffusing on the surface and inside smaller primary particles; higher concentration polarization reduces the battery voltage and significantly deteriorates the low-temperature starting performance of the battery.

Preferably, the ratio of A to B is (2.5-8):1. Further optimizing the ratio of the primary particle size of lithium iron phosphate to the average particle size of the conductive agent can further reduce the internal resistance of the battery, better improve the cycle life and storage performance of the battery; and further reduce the concentration polarization during lithium ion diffusion, better enhance the low-temperature cold start performance of the battery.

Furthermore, based on the ratio of the number of lithium iron phosphate to the number of conductive agent within the above-mentioned range, adjusting the ratio of the primary particle size of lithium iron phosphate to the average particle size of the conductive agent within the preferred range can further reduce the internal resistance of the battery, improve the cycle performance, storage performance, and capacity of the battery, and better enhance the low-temperature cold start performance of the battery.

In some embodiments, the primary particle size A of the lithium iron phosphate is 100 nm-600 nm, for example, it can be 100 nm, 200 nm, 300 nm, 400 nm, 500 nm, 600 nm, or any range composed of any two of the aforementioned values and any point value within that range, more preferably 140 nm-300 nm. When the primary particle size of lithium iron phosphate is within the above-mentioned range, the lithium iron phosphate is not prone to aggregation, the number of contact points between lithium iron phosphate particles is reduced, the internal resistance of the battery is lowered, and the concentration polarization during lithium ion diffusion is reduced, thus making the battery to have good cycle life, storage performance, and low-temperature cold start performance.

In some embodiments, a specific surface area C of the lithium iron phosphate is 8 m²/g-15 m²/g, for example, it can be 8 m²/g, 9 m²/g, 10 m²/g, 11 m²/g, 12 m²/g, 13 m²/g, 14 m²/g, 15 m²/g, or any range composed of any two of the aforementioned values and any point value within that range.

The testing method for the specific surface area of lithium iron phosphate includes: loading the dried lithium iron phosphate sample into a sample tube, and connecting the sample tube to a TriStar II 3020 analyzer for pretreatment. Then, placing the sample tube in liquid nitrogen for adsorption measurement, recording the adsorption amount, relative pressure, etc. during the adsorption measurement process, and calculating the specific surface area of the lithium iron phosphate sample according to the BET equation.

In some embodiments, the average particle size B of the conductive agent is 10 nm-100 nm, for example, it can be 10 nm, 20 nm, 30 nm, 40 nm, 50 nm, 60 nm, 70 nm, 80 nm, 90 nm, 100 nm, or any range composed of any two of the aforementioned values and any point value within that range, more preferably 40 nm-70 nm. If the average particle size of the conductive agent is too large, the contact area between the positive active material and the conductive agent will decrease, reducing the conductive effect and increasing the internal resistance of the battery. If the average particle size of the conductive agent is too small, it may form a higher specific surface area, resulting in higher surface energy and instability, which can cause more side reactions and reduce the capacity and cycle life of the battery. Therefore, when the average particle size of the conductive agent is within the above range, the adverse effects of excessively large or small particle size of the conductive agent can be avoided, and then improve the capacity and cycle life of the battery.

Furthermore, based on the ratio of the number of lithium iron phosphate to the number of conductive agent within the above-mentioned range, adjusting the value range of the primary particle size of lithium iron phosphate and the value range of the average particle size of the conductive agent can further enhance the cycle performance and capacity of the battery.

In some embodiments, a surface resistivity of the positive electrode plate is denoted as R Ω·cm; the relationship between the primary particle size A of the lithium iron phosphate and the surface resistivity R of the positive electrode plate satisfies: 0.18≤A/R≤3, for example, the ratio can be 0.18, 0.20, 0.23, 0.5, 1, 1.5, 2, 2.5, or 3, or any range composed of any two of the aforementioned values and any point value within that range. The surface resistivity of the positive electrode plate is closely related to the primary particle size of the lithium iron phosphate. For example, when the particle size of the lithium iron phosphate is too small, it not only fails to make close contact with the conductive agent but also exhibits poor contact with a current collector. This situation reduces the number of conductive channels, increases the impedance of the lithium-ion battery, and further increases the contact resistance between the positive active material and the current collector (i.e., increases the surface resistivity of the positive electrode plate), further increasing the internal resistance of the lithium-ion battery, weakening the low-temperature cold start performance, cycle performance, and storage performance. For example, when the particle size of the lithium iron phosphate is too large, the diffusion path of lithium ions becomes longer, and lithium ions generate higher concentration polarization when diffusing on the surface and inside larger primary particles, while the concentration polarization during diffusion on the surface and inside smaller primary particles is lower. The higher concentration polarization reduces the battery voltage and severely deteriorates the low-temperature cold start performance. The present disclosure limits that when the ratio of the primary particle size of the lithium iron phosphate to the surface resistivity of the positive electrode plate satisfies the above-mentioned range, it can avoid the adverse effects on the low-temperature cold start performance, cycle performance, and storage performance caused by the excessively small primary particle size of the lithium iron phosphate, which leads to a high surface resistivity of the positive electrode plate. Additionally, it can also avoid adverse effects on the low-temperature performance caused by the excessively large primary particle size of the lithium iron phosphate, thereby comprehensively improving the low-temperature cold start performance, cycle performance, and storage performance of the battery.

Further, based on the ratio of the number of lithium iron phosphate to the number of conductive agent within the above-mentioned range, and the ratio of the primary particle size of lithium iron phosphate to the average particle size of the conductive agent and their values in the above-mentioned range, adjusting the ratio of the primary particle size of lithium iron phosphate to the surface resistivity of the positive electrode plate can further reduce the internal resistance of the battery, improve the cycle performance, storage performance, and capacity of the battery, and better enhance the low-temperature cold start performance of the battery.

In some embodiments, the surface resistivity R of the positive electrode plate is 200 Ω·cm-600 Ω·cm, for example, it can be 200 Ω·cm, 300 Ω·cm, 400 Ω·cm, 500 Ω·cm, 600 Ω·cm, or any range composed of any two of the aforementioned values and any point value within that range. When the surface resistivity of the positive electrode plate is within the above-mentioned range, it can better promote charge transfer transport within the positive electrode plate, reduce the electrochemical impedance of the electrode during charging and discharging processes, and improve the cycle performance, storage performance, and low-temperature cold start performance of the battery.

In the present disclosure, the method for testing the surface resistivity of the positive electrode plate includes: under a pressure of 4 kN, using a high-precision four-probe instrument based on a four-probe constant current principle to test the resistance value and thickness of a lithium battery positive electrode plate sample, with the testing software automatically calculating its resistivity.

In some embodiments, the positive electrode plate further includes a binder; a mass ratio of the conductive agent to the binder is 1:(0.3-2), for example, it can be 1:0.3, 1:0.5, 1:0.8, 1:1.0, 1:1.2, 1:1.5, 1:1.8, or 1:2, or any range composed of any two of the aforementioned values and any point value within that range, preferably 1:(0.4-1.6). In the present disclosure, the ratio of the number of lithium iron phosphate to the number of conductive agent can be adjusted by adjusting the mass ratio of the conductive agent to the binder. For example, in the positive electrode plate, when the mass proportion of the lithium iron phosphate remains unchanged, adjusting the mass ratio of the conductive agent to the binder, when the mass proportion of the conductive agent is higher, the ratio of the number of lithium iron phosphate to the number of conductive agent will decrease; when the mass proportion of the conductive agent is lower, the ratio of the number of lithium iron phosphate to the number of conductive agent will increase. In other embodiments, it is also possible not to adjust the mass proportion of the binder, but only to adjust the mass proportions of the lithium iron phosphate and the conductive agent, and then the ratio of the number of lithium iron phosphate particles to the number of conductive agent can be adjusted.

When the mass ratio of the conductive agent to the binder is within the above-mentioned range, the ratio of the number of lithium iron phosphate particles to the number of conductive agent can be maintained within the scope of the present disclosure. This, in turn, helps to form a good conductive network, reduce the internal resistance of the lithium-ion battery, improve charge transfer efficiency, enhance the capacity performance of the battery, and achieve an improvement in the cycle performance of lithium ions.

In some embodiments, in the positive electrode plate, a mass proportion of the binder is 2%-5%, for example, it can be 2%, 2.5%, 3%, 3.5%, 4%, 4.5%, 5%, or any range composed of any two of the aforementioned values and any point value within that range. When the mass proportion of the binder is within the above-mentioned range, it can adhere the positive active material and the conductive agent to the current collector, form a stable electrode structure, improve a peeling force of the electrode plate, prevent the positive active material and the conductive agent from falling off during charging and discharging processes, and improve the cycle life of the battery.

In some embodiments, a peeling strength of the positive electrode plate is 4 gf/mm-25 gf/mm, for example, it can be 4 gf/mm, 5 gf/mm, 8 gf/mm, 10 gf/mm, 12 gf/mm, 15 gf/mm, 18 gf/mm, 20 gf/mm, 22 gf/mm, 25 gf/mm, or any range composed of any two of the aforementioned values and any point value within that range. The peeling strength of the positive electrode plate is related to the mass proportion of the binder, the higher the mass proportion of the binder, the higher the peeling strength. If the peeling force is too low (less than 4 gf/mm), the powder is likely to fall off, resulting in a decrease in capacity and a reduction in cycle performance. If the peeling force is too high (greater than 25 gf/mm), there will be an excessive amount of binder, making the positive electrode plate brittle and prone to breakage.

In some embodiments, a press density of the positive electrode plate is 1.8 g/cm³-2.5 g/cm³, for example, it can be 1.8 g/cm³, 1.9 g/cm³, 2 g/cm³, 2.1 g/cm³, 2.2 g/cm³, 2.3 g/cm³, 2.4 g/cm³, 2.5 g/cm³, or any range composed of any two of the aforementioned values and any point value within that range. When the press density of the positive electrode plate is within the above-mentioned range, it can increase the contact between the positive active material and the conductive agent, improve the rate and efficiency of the electrochemical reaction, and then enhance the capacity and cycle performance of the battery.

In some embodiments, the conductive agent includes at least one of conductive carbon black, conductive graphite, acetylene black, Keqin black, graphene, conductive carbon fiber, carbon nanotube, metal powder, or carbon fiber.

In some embodiments, the binder includes at least one of polyvinylidene fluoride (PVDF), polytetrafluoroethylene (PTFE), polyoxyethylene (PEO), sodium carboxymethyl cellulose, or styrene-butadiene rubber (SBR).

A second aspect of the present disclosure provides a battery including the positive electrode plate according to the first aspect of the present disclosure.

In some embodiments, the battery includes a separator; the separator includes a base film and an adhesive layer disposed on at least one side surface of the base film. The adhesive layer can enhance the mechanical strength of the separator, reduce the shrinkage and melting of the separator in a high-temperature environment, and then maintain the structural integrity of the battery, and improve the structural stability and cycle performance of the lithium-ion battery.

In some embodiments, the base film includes at least one of polyethylene, polypropylene, multilayer polyethylene polypropylene, polyethylene polypropylene blend, polyimide, polyetherimide, polyamide, meta-aramid, para-aramid, or meta-para blended aramid.

In some embodiments, the adhesive layer includes at least one of vinylidene fluoride-hexafluoropropylene copolymer, vinylidene fluoride-trichloroethylene copolymer, polystyrene, polyacrylic acid ester, polyacrylic acid, polyacrylonitrile, polyvinylpyrrolidone, polyvinyl acetate, ethylene-vinyl acetate copolymer, polyimide, poly(p-phenylene terephthalamide), acrylonitrile-styrene-butadiene copolymer, polyvinyl alcohol, styrene-butadiene copolymer, and polyvinylidene fluoride.

In some embodiments, a projected area proportion of the adhesive layer on the base film is denoted as S, the primary particle size of the lithium iron phosphate is denoted as A nm, the relationship between S and A satisfies: 0.03≤S/A≤0.35. For example, S/A can be 0.03, 0.05, 0.1, 0.15, 0.2, 0.25, 0.3, or 0.35, or any range composed of any two of the aforementioned values and any point value within that range, more preferably 0.1≤S/A≤0.25. When the S/A ratio is too small, that is, the projected area proportion of the adhesive layer on the base film is too small, an uneven pore size distribution is formed on the surface of the separator, and low-resistance channels appear in local areas. During the charging process, lithium ions deintercalate from the positive electrode too quickly through these low-resistance channels, pass through the separator, and reach and intercalate into the negative electrode, causing lithium ions that cannot fully intercalate into the negative electrode to gain electrons on the surface of the negative electrode, thus easily forming metallic lithium and causing lithium deposition phenomenon. When the S/A ratio is too large, that is, the projected area proportion of the adhesive layer on the base film is too large, and the primary particle size of lithium iron phosphate is too small, the impedance of the lithium-ion battery will increase, weakening the low-temperature cold start performance, cycle performance, and storage performance. When the S/A ratio falls within the above-defined range, it can reduce the thickness expansion rate of the battery cell, effectively prevent the occurrence of the lithium deposition phenomenon, and improve battery safety. Additionally, it also enables the battery to exhibit excellent low-temperature cold start performance, cycle performance, and storage performance.

Further, when the ratio of the number of lithium iron phosphate to the number of conductive agent is within the above-mentioned range, adjusting the ratio of the projected area proportion S of the adhesive layer on the base film to the primary particle size A of lithium iron phosphate can enhance the cycle performance, storage performance, and battery capacity, and further effectively prevent the occurrence of lithium deposition phenomenon, improve the safety of the battery.

In some embodiments, the projected area proportion S of the adhesive layer on the base film is 15%-35%. For example, it can be 15%, 18%, 20%, 22%, 25%, 28%, 30%, or 35%, or any range composed of any two of the aforementioned values and any point value within that range. When the area ratio of the adhesive layer falls within the above-mentioned range, it can maintain the conductivity of the separator within an appropriate range. This not only accelerates the migration rate of lithium ions within the battery cell but also prevents lithium deposition on the negative electrode, thereby improving the cycle performance and charge-discharge efficiency of the battery.

The testing method for the projected area ratio of the adhesive layer on the base membrane includes: imaging the surface of the separator sample using SEM, selecting an arbitrary area within a 250 μm×250 μm region, measuring the area covered by the adhesive layer, and calculating the proportion of the adhesive layer within this region, which represented the projected area ratio of the adhesive layer on the base membrane.

In some embodiments, the specific surface area of the lithium iron phosphate is denoted as C m²/g, the thermal shrinkage rate of the separator is denoted as L %, and the relationship between C and L satisfies: 0.16≤C/L≤0.75, for example, C/L can be 0.16, 0.2, 0.3, 0.4, 0.5, 0.6, 0.7, or 0.75, or any range composed of any two of the aforementioned values and any point value within that range. When the C/L ratio is too large, that is, the specific surface area of lithium iron phosphate is too large (the primary particle size is too small) and the thermal shrinkage of the separator is too small, the closing of the separator pores prevents the exchange of lithium ions between the positive and negative electrodes, increasing the internal resistance. Moreover, the loose contact between lithium iron phosphate and the current collector also leads to a relatively large internal resistance. Excessive internal resistance also seriously hinders the lithium-ion transmission channels and also significantly affects the cycle performance and cold start capability of the lithium-ion battery. When the C/L ratio is too small, that is, when the specific surface area of lithium iron phosphate is too small and the thermal shrinkage rate of the separator is too large, the separator is extremely prone to deformation or even rupture. Excessive shrinkage can lead to electrode contact and short circuit. The larger specific surface area of lithium iron phosphate and the smaller thermal shrinkage rate of the separator, the larger gap between the positive electrode plate and the separator. When the C/L ratio meets the above conditions, the gap between the positive electrode plate and the separator is appropriate, allowing the separator to fully contact with an electrolyte solution to enhance wettability, which helps to reduce the internal resistance of both the separator and the lithium-ion battery. Meanwhile, the separator pores are less likely to collapse at high temperatures, which is conducive to the transmission of lithium ions.

Further, when the ratio of the number of lithium iron phosphate to the number of conductive agent is within the above-mentioned range, adjusting the ratio of the specific surface area of lithium iron phosphate to the thermal shrinkage rate of the separator can further enhance the electrolyte solution wettability, thereby better improving the cycle performance, storage performance, and safety performance of the battery.

In some embodiments, the thermal shrinkage rate L of the separator is 20%-50%, for example, it can be 20%, 25%, 30%, 35%, 40%, 45%, 50%, or any range composed of any two of the aforementioned values and any point value within that range. The thermal shrinkage rate of the separator can be tested by a TMA/SDTA 2+ instrument produced by Mettler or other instruments with similar functions. A test method for the thermal shrinkage rate of the separator includes: clamping a pre-treated separator sample in a test station, setting a test temperature (150° C.-170° C.), and heat shrinkage time. When the test temperature is reached, start the test. Then, the heating hood descends, and the sample is exposed to a high-temperature environment. The shrinkage of the material generates a shrinkage force, which is applied to a sensor. By analyzing and calculating the electrical signal from the sensor, the thermal shrinkage rate of the sample at 150° C.-170° C. is obtained.

In some embodiments, the battery includes a negative electrode plate, and the negative electrode plate includes a negative active material. Preferably, the negative active material includes at least one of graphite, hard carbon, mesocarbon microbead, silicon carbide, silicon oxide, nano-silicon, or silicon alloy.

In some embodiments, the negative active material includes graphite and hard carbon. Preferably, in the negative active material, and a proportion of hard carbon is 0 wt %-30 wt %, a proportion of graphite is 70 wt %-100 wt %. The combined use of graphite and hard carbon can improve the energy density of the battery and enhance its cycle performance.

Further, when the ratio of the number of lithium iron phosphate to the number of conductive agent is within the above-mentioned range, adjusting the negative active material to include graphite and hard carbon can further enhance the energy density of the battery, thereby better improving the cycle performance and capacity of the battery.

The technical solution in the embodiments of the present disclosure will be clearly described below in combination with the embodiments of the present disclosure. Obviously, the described embodiments are only part of the embodiments of the present disclosure, rather than all of them. All other embodiments obtained by those of ordinary skill in the conventional technology without creative effort based on the embodiments of the present disclosure shall fall within the scope of protection of the present disclosure.

Unless otherwise specified, materials, reagents, etc. used in the following embodiments can be obtained from commercial sources.

The present disclosure is described in detail below with reference to specific embodiments, which are used to understand rather than limit the present disclosure.

The batteries in the examples and comparative examples were all prepared according to the following preparation method:

### Example 1-1

### (1) Preparation of a Positive Electrode Plate

Active material Lithium iron phosphate (primary particle size A is 300 nm, specific surface area C is 12 m²/g), binder PVDF, and conductive carbon black SP (average particle size B is 50 nm) were stirred and mixed to form a uniform and stable mixture. In the mixture, a solid component included 93.5 wt % of lithium iron phosphate, 2.5 wt % of binder PVDF, and 4 wt % of conductive carbon black SP. Using N-methylpyrrolidone (NMP) as a solvent, a positive active material slurry was prepared, with a solid content in the slurry being 56 wt %-60 wt %. The slurry was evenly applied on both sides of an aluminum foil, followed by drying and compaction by a roller press to obtain the positive electrode plate. The surface resistivity R of the positive electrode plate is 500 (2·cm, and the peeling strength of the positive electrode plate is 10.46 gf/mm.

### (2) Preparation of a Negative Electrode Plate

Active materials graphite and hard carbon HC, binder SBR, and conventional conductive agent were mixed by stirring to form a uniform and stable mixture. In the mixture, a solid component included 80.75 wt % of graphite G, 14.25 wt % of hard carbon HC, 2 wt % of binder SBR, 0.6 wt % of multi-walled carbon nanotube, and 2.4 wt % of conductive carbon black. Using water as a solvent, a negative active material slurry was prepared, with a solid content in the slurry being 46 wt %. The slurry was evenly applied on both sides of a copper foil, followed by drying and compaction by a roller press to obtain the negative electrode plate.

### (3) Preparation of a Separator

A base film of a separator was made of polyethylene, and an adhesive layer was PVDF. The projected area of the adhesive layer was adjusted by a rotary spraying method, and the projected area proportion S of the adhesive layer was 30%. The thermal shrinkage rate L of the separator was 30%.

### (4) Assembly of a Battery

The positive electrode plate, the negative electrode plate, and the separator obtained in the above steps were punched and wound to form a bare battery cell. After thermal pressing, aluminum tabs and nickel-plated copper tabs were welded. The aluminum-plastic film was stamped to form pits, encapsulated, and vacuum-baked at 95° C. for 24 hours. An electrolyte solution used was a IM lithium hexafluorophosphate solution, with a mixed solvent of ethylene carbonate, dimethyl carbonate, and 1,2-propylene carbonate at a volume ratio of 1:1:1. After electrolyte solution injection, the battery underwent formation, sorting, and open circuit voltage (OCV) testing to obtain a pouch cell.

In Example Group 1, the mass ratio of the conductive agent to the binder in the positive electrode plate was adjusted to change the ratio of the number of lithium iron phosphate to the number of conductive agent, with specific different characteristics shown in Table 1. In Example Group 2, the preparation was carried out by referring to Example 1-1, the primary particle size A of lithium iron phosphate and the average particle size B of the conductive agent were changed, with specific different characteristics shown in Table 1. In Example Group 3, the preparation was carried out by referring to Example 1-1, and the primary particle size A of lithium iron phosphate and the mass ratio of the conductive agent to the binder in the electrode plate were adjusted to change the surface resistivity R of the positive electrode plate and the A/R ratio (while keeping the total mass of conductive agent and binder unchanged), with specific different characteristics shown in Table 1. In Comparative Example 1, an excessive amount of conductive agent was added, and the ratio of the number of lithium iron phosphate to the number of conductive agent exceeded the protection scope of the present disclosure, with specific different characteristics shown in Table 1. In Comparative Example 2, an insufficient amount of conductive agent was added, and the ratio of the number of lithium iron phosphate to the number of conductive agent exceeded the protection scope of the present disclosure (in the positive electrode plate, the solid component included 97 wt % of lithium iron phosphate, 2.5 wt % of binder PVDF, and 0.5 wt % of conductive carbon black SP).

TABLE 1

| | | | | | | | | Surface | | |
|---|---|---|---|---|---|---|---|---|---|---|
| | Ratio of the | | | | | Average | | resistivity | | |
| | number of | Mass | | Mass ratio | | particle | | R of the | | |
| | lithium iron | proportion | Mass | of the | Primary | size of the | | positive | | |
| | phosphate to | of | proportion | conductive | particle | conductive | | electrode | | Peeling |
| | conductive | conductive | of the | agent to | size | agent | | plate R/ | | strength |
| Example | agent | agent | binder | the binder | A/nm | B/nm | A/B | Ω · cm | A/R | gf/mm |
| Example 1-1 | 1:20 | 4% | 2.5% | 1:0.625 | 300 | 50 | 6:1 | 500 | 0.6 | 10.46 |
| Example 1-2 | 1:8 | 2.5% | 4% | 1:1.6 | * | * | * | 552 | 0.54 | 13.28 |
| Example 1-3 | 1:12 | 3% | 3.5% | 1:1.16 | * | * | * | 534 | 0.56 | 12.39 |
| Example 1-4 | 1:16 | 3.5% | 3% | 1:0.857 | * | * | * | 518 | 0.58 | 11.47 |
| Example 1-5 | 1:35 | 4.5% | 2% | 1:0.44 | * | * | * | 400 | 0.75 | 9.51 |
| Example 1-6 | 1:4 | 1% | 5.5% | 1:5.5 | * | * | * | 600 | 0.5 | 20.19 |
| Example 1-7 | 1:50 | 5.5% | 1% | 1:0.18 | * | * | * | 200 | 1.5 | 6.13 |
| Example 2-1 | * | * | * | * | 200 | 100 | 2:1 | 550 | 0.36 | 10.45 |
| Example 2-2 | * | * | * | * | 600 | 10 | 60:1 | 350 | 1.71 | 10.41 |
| Example 2-3 | * | * | * | * | 100 | 66.7 | 1.5:1 | 570 | 0.18 | 10.44 |
| Example 2-4 | * | * | * | * | 800 | 10 | 80:1 | 260 | 3.08 | 10.42 |
| Example 3-1 | 1:35 | 4.5% | 2% | 1:0.44 | 108 | * | 2.8:1 | 600 | 0.18 | 9.51 |
| Example 3-2 | 1:35 | 4.5% | 2% | 1:0.44 | 600 | * | 12:1 | 200 | 3 | 9.51 |
| Example 3-3 | 1:12 | 3% | 3.5% | 1:1.16 | 700 | * | 14:1 | 200 | 3.5 | 12.39 |
| Example 3-4 | 1:12 | 3% | 3.5% | 1:1.16 | 100 | * | 2:1 | 600 | 0.17 | 12.39 |
| Comparative | 1:60 | 6% | 0.5% | 1:0.42 | * | * | * | 160 | 1.88 | 10.95 |
| Example 1 | | | | | | | | | | |
| Comparative | 1:0.2 | 0.5% | 2.5% | 1:5 | * | * | * | 1500 | 0.2 | 10.23 |
| Example 2 | | | | | | | | | | |

Note:
“*” indicates that the corresponding parameter in the Example or the Comparative Example is the same as that in Example 1-1.

In Example Group 4, the preparation was carried out by referring to Example 1-1, and the primary particle size A of lithium iron phosphate and the projection area of the adhesive layer were adjusted to change the S/A ratio, with specific different characteristics shown in Table 2. In Example Group 5, the preparation was carried out by referring to Example 1-1, and the specific surface area C of lithium iron phosphate and the thermal shrinkage rate L of the separator were adjusted to change the C/L ratio, with specific different characteristics shown in Table 2. In Example Groups 4 and 5, the peeling strength of the positive electrode plate was 8 gf/mm-15 gf/mm. In Example Groups 6 and 7, and in Comparative Example 3, the peeling strength of the positive electrode plate was 8 gf/mm-15 gf/mm.

TABLE 2

| | | Projected area | | Specific surface | | |
|---|---|---|---|---|---|---|
| | Primary | proportion | | area C of the | Thermal | |
| | particle | of the | | lithium iron | shrinkage | |
| | size | adhesive | | phosphate/ | rate of the | |
| | A/nm | layer S | S/A | m²/g | separator L | C/L |
| Example 4-1 | 500 | 15% | 0.03 | 8 | * | 0.27 |
| Example 4-2 | 100 | 35% | 0.35 | 20 | * | 0.67 |
| Example 4-3 | 700 | 10% | 0.014 | 7 | * | 0.23 |
| Example 4-4 | 100 | 40% | 0.4 | 20 | * | 0.67 |
| Example 5-1 | 500 | * | 0.06 | 8 | 50% | 0.16 |
| Example 5-2 | 200 | * | 0.15 | 15 | 20% | 0.75 |
| Example 5-3 | 800 | * | 0.04 | 6 | 55% | 0.1 |
| Example 5-4 | 180 | * | 0.17 | 16 | 18% | 0.88 |

Note:
“*” indicates that the corresponding parameter in the Example or the Comparative Example is the same as that in Example 1-1.

Example Group 6: The preparation was carried out by referring to Example 1-1, and the negative active material was changed. The specific differences are as follows:
Example 6-1: The negative active material was 50 wt % graphite and 45 wt % hard carbon;
Example 6-2: The negative active material was 30 wt % graphite and 65 wt % hard carbon;
Example 6-3: The negative active material was 95 wt % graphite.
Example Group 7: The preparation was carried out by referring to Example 1-1, and the conductive agent in the positive electrode plate was changed. The specific differences are as follows:
Example 7-1: An equal amount of conductive graphite was used to replace the conductive carbon black;
Example 7-2: The conductive agent was a mixture of conductive graphite and conductive carbon black at a mass ratio of 1:1.
Comparative Example 3: The preparation was carried out by referring to Example 1-1,

and an equal amount of lithium manganese iron phosphate was used to replace lithium iron phosphate.

For the batteries obtained in the above Examples and Comparative Examples, the following performance tests were carried out:

### (1) Cold Start Test Method for Cell:

In a (25±2)° C. environment, a cell was discharged at a constant current of 1 C to a discharge termination voltage of 2.2 V, and left standing for 30 min; then charged at a constant current of 1 C to a charging limit voltage of 3.65 V with a cut-off current of 0.05 C, and left standing for 30 min; discharged at a constant current of 1 C to a discharge termination voltage of 2.2 V to obtain an actual capacity C0 of the cell, and left standing for 30 min; charged again at a constant current of 1 C to a constant voltage of 3.65 V with a cut-off current of 0.05 C, and discharged at 1 C for 30 min to achieve 50% state of charge (SOC). After standing at (25±2) C for 2 h, the cell a was placed in a −30 C constant temperature chamber and kept at constant temperature for 4 h; the terminal voltage value during a constant current discharge of 18 C for 0.2 s was tested, which is defined as the cold start terminal voltage of the cell, with the unit of V.

### (2) Cycle Test Method for Cell:

At 55 C, a cell was discharged at a constant current of 3 C to a discharge termination voltage of 2.2 V, and left standing for 30 min; then charged at a constant current of 3 C to a charging limit voltage of 3.65 V with a cut-off current of 0.05 C, and left standing for 30 min; discharged again at a constant current of 3 C to a discharge termination voltage of 2.2 V, and left standing for 30 min; the above steps of full charge-discharge were repeated until the capacity decayed to 80%, and the number of repeated cycles was defined as the cycle number to evaluate the cycle performance of the battery after aging.

### (3) Storage Capacity Retention Test Method for Cell:

In a (25±2)° C. environment, a cell was discharged at a constant current of 1 C to a discharge termination voltage of 2.2 V, and left standing for 30 min; then charged at a constant current of 1 C to a charging limit voltage of 3.65 V with a cut-off current of 0.05 C, and left standing for 30 min; discharged again at a constant current of 1 C to a discharge termination voltage of 2.2 V to obtain an initial capacity C0 of the cell, and left standing for 30 min; charged once more at a constant current of 1 C to a charging limit voltage of 3.65 V with a cut-off current of 0.05 C, followed by open-circuit standing at 70 C for 15 days. After standing at (25±2)° C. for 1 h, the cell was discharged at a constant current of 1 C to a discharge termination voltage of 2.2 V, charged again at a constant current of 1 C to a charging limit voltage of 3.65 V with a cut-off current of 0.05 C, and then discharged at a constant current of 1 C to a discharge termination voltage of 2.2 V to obtain a recovered capacity C1; a storage capacity retention rate of the cell was C1/C0×100%.

### (4) Test Method for Peeling Strength:

The test method for peeling strength was as follows: a rolled positive electrode plate sample was mounted on a fixture, and a peel test was performed using a testing instrument, where the ratio of the obtained peeling force to the width was defined as the peeling strength.

### (5) Test Method for Internal Resistance:

In a (25±2)° C. environment, a cell was discharged at a constant current of 1 C to a discharge termination voltage of 2.2 V, and left standing for 30 min; then charged at a constant current of 1 C to a charging limit voltage of 3.65 V with a cut-off current of 0.05 C, and left standing for 30 min; discharged again at a constant current of 1 C to a discharge termination voltage of 2.2 V to obtain an actual capacity C0; left standing for 30 min; charged at a constant current of 1 C to a charging limit voltage of 3.65 V with a cut-off current of 0.05 C, and discharged at 1 C for 30 min to achieve 50% SOC, followed by standing for 2 h and recording the voltage V1. In the (25±2)° C. environment, discharged at 10 C for 10 s at 50% SOC, and the discharge current I and terminal discharge voltage V2 were recorded. A direct current internal resistance (DCIR) was calculated as follows: DCIR=(V1−V2)/I.

### (6) Test Method for Lithium Deposition:

In a (25±2)° C. environment, a cell was discharged at a constant current of 1 C to a discharge termination voltage of 2.2 V, and left standing for 30 min; then charged at a constant current of 1 C to a charging limit voltage of 3.65 V with a cut-off current of 0.05 C, and left standing for 30 min; discharged again at a constant current of 1 C to a discharge termination voltage of 2.2 V, and an initial thickness of the cell PPG1 was measured, followed by standing for 30 min; charged at a constant current of 1 C to a charging limit voltage of 3.65 V with a cut-off current of 0.05 C, then left standing open-circuit at 80 C for 30 days, and a thickness of the cell PPG2 was measured; a thickness expansion rate of the cell was (PPG2−PPG1)/PPG1×100%, and lithium deposition was recorded when the thickness expansion rate exceeded 30%.

The results of the performance tests on the above batteries were recorded in Tables 3 and 4.

TABLE 3

| | Cold start | Cycle | Storage | Internal |
|---|---|---|---|---|
| | terminal voltage | number | capacity | resistance |
| | of the cell (V) | (T) | retention rate | (mΩ) |
| Example 1-1 | 2.16 | 1510 | 92.1% | 1.1 |
| Example 1-2 | 1.81 | 1370 | 90.6% | 1.2 |
| Example 1-3 | 1.85 | 1420 | 91.0% | 1.18 |
| Example 1-4 | 2.00 | 1460 | 91.5% | 1.15 |
| Example 1-5 | 2.29 | 1550 | 92.5% | 1.08 |
| Example 1-6 | 1.35 | 1080 | 88.6% | 1.8 |
| Example 1-7 | 1.98 | 1430 | 91.2% | 1.16 |
| Example 2-1 | 2.03 | 1480 | 91.6% | 1.14 |
| Example 2-2 | 2.01 | 1490 | 91.8% | 1.15 |
| Example 2-3 | 1.80 | 1390 | 90.8% | 1.2 |
| Example 2-4 | 1.76 | 1380 | 91.0% | 1.23 |
| Example 3-1 | 2.11 | 1400 | 91.5% | 1.12 |
| Example 3-2 | 2.18 | 1460 | 91.8% | 1.09 |
| Example 3-3 | 2.1 | 1350 | 90.7% | 1.12 |
| Example 3-4 | 2.05 | 1290 | 90.0% | 1.14 |
| Example 4-1 | 2.1 | 1400 | 91.1% | 1.12 |
| Example 4-2 | 2.13 | 1420 | 91.8% | 1.11 |
| Example 4-3 | 1.85 | 1100 | 87.0% | 1.18 |
| Example 4-4 | 1.96 | 1300 | 90.0% | 1.16 |
| Example 5-1 | 2.15 | 1390 | 91.6% | 1.1 |
| Example 5-2 | 2.11 | 1310 | 91.2% | 1.12 |
| Example 5-3 | 2.08 | 1260 | 91.0% | 1.13 |
| Example 5-4 | 1.82 | 1120 | 90.5% | 1.28 |
| Example 6-1 | 2.23 | 1511 | 91.2% | 1.09 |
| Example 6-2 | 2.29 | 1508 | 90.4% | 1.08 |
| Example 6-3 | 2 | 1512 | 92.3% | 1.15 |
| Example 7-1 | 2.09 | 1380 | 91.6% | 1.13 |
| Example 7-2 | 2.12 | 1420 | 91.8% | 1.11 |
| Comparative | 1.70 | 1000 | 86.0% | 1.30 |
| Example 1 | | | | |
| Comparative | 1.58 | 900 | 80.0% | 1.50 |
| Example 2 | | | | |
| Comparative | 1.72 | 1020 | 82.0% | 1.31 |
| Example 3 | | | | |

As can be seen from the results in Table 3, for the positive electrode plate and battery provided by the present disclosure, when adjusting the ratio of the number of lithium iron phosphate to the number of conductive agent in the positive electrode plate within a specific range, it helps form a good conductive network, reduces the internal resistance of the lithium-ion battery, and improves the cycle performance and capacity retention rate of the battery.

TABLE 4

| Embodiment | Thickness expansion rate | Lithium deposition test |
|---|---|---|
| Example 1-1 | 8% | No lithium deposition |
| Example 4-1 | 12% | No lithium deposition |
| Example 4-2 | 9% | No lithium deposition |
| Example 4-3 | 32% | Lithium deposition |
| Example 4-4 | 18% | No lithium deposition |

As can be seen from the results in Table 4, when the relationship between the projected area proportion S of the adhesive layer on the base film and the primary particle size A of lithium iron phosphate satisfies 0.03≤S/A≤0.35, it can reduce the thickness expansion rate of the cell, effectively prevent the occurrence of lithium deposition, and improve the safety of the battery.

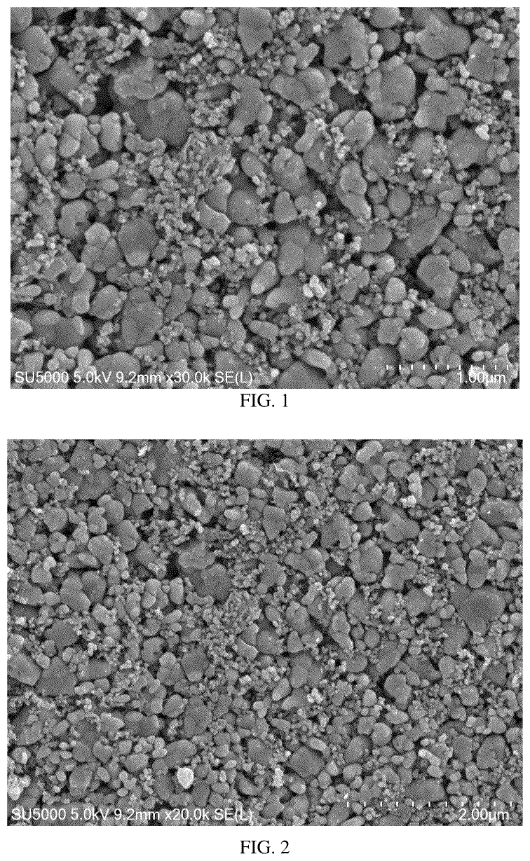

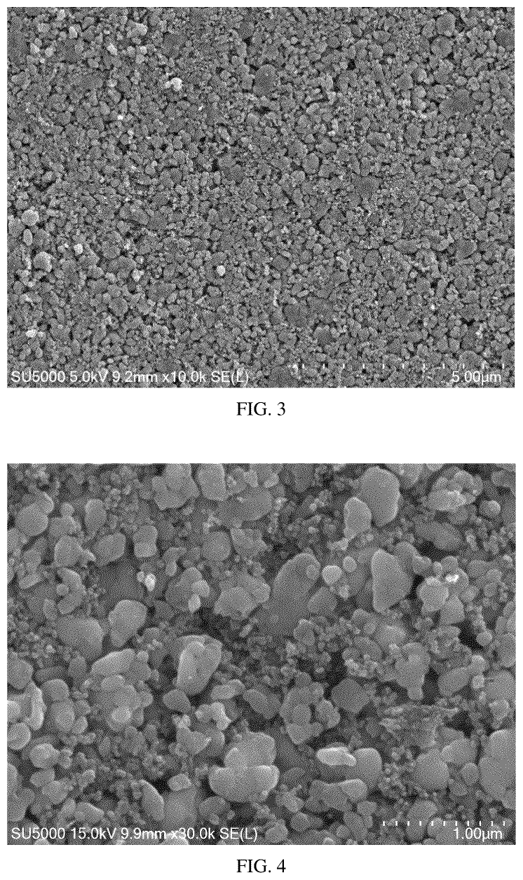

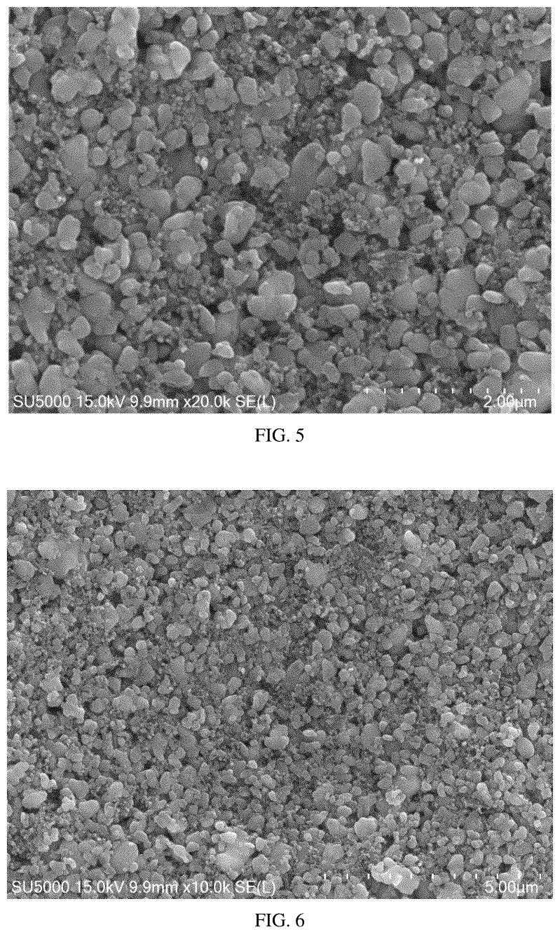

As shown in FIGS. 1-3, the SEM images of the surface of the rolled positive electrode plate in Example 1-1 show that, more conductive carbon black is distributed around lithium iron phosphate, which helps form a better conductive network, improves charge transfer efficiency, and enhances the cycle capability of the battery. As shown in FIGS. 4-6, the SEM images of the surface of the rolled positive electrode in Example 1-3 show that, less conductive carbon black is distributed around lithium iron phosphate, resulting in slightly poorer conductivity.

It should be noted that herein, the terms “comprise”, “include”, or any other variants thereof are intended to cover non-exclusive inclusion, such that a process, method, article, or device comprising a series of elements not only includes those elements but also includes other elements not explicitly listed, or further includes elements inherent to such process, method, article, or device. Without further limitation, an element defined by the phrase “comprising a . . . ” does not exclude the presence of additional identical elements in the process, method, article, or device comprising that element. Additionally, it should be pointed out that the scope of the methods and devices in the embodiments of this application is not limited to performing functions in the order shown or discussed, but may also include performing functions in a substantially simultaneous manner or in the reverse order according to the functions involved. For example, the described methods may be executed in an order different from that described, and various steps may be added, omitted, or combined. Furthermore, features described with reference to certain embodiments may be combined in other embodiments.

The above are only preferred embodiments of the present disclosure and are not intended to limit the present disclosure. Any modifications, equivalent substitutions, and the like made within the spirit and principles of the present disclosure shall be included in the protection scope of the present disclosure.

What is claimed is:

1. A positive electrode plate, wherein the positive electrode plate comprises a positive active material and a conductive agent; the positive active material comprises lithium iron phosphate; and
in the positive electrode plate, within a unit area of 1 μm×1 μm, a ratio of a number of lithium iron phosphate to a number of conductive agent is 1:(0.5-50).

2. The positive electrode plate according to claim 1, wherein in the positive electrode plate, within a unit area of 1 μm×1 μm, the ratio of the number of lithium iron phosphate to the number of conductive agent is 1:(5-40).

3. The positive electrode plate according to claim 1, wherein in the positive electrode plate, a mass proportion of the positive active material is 90%-95%;
and/or, in the positive electrode plate, a mass proportion of the conductive agent is 2%-5%.

4. The positive electrode plate according to claim 1, wherein a primary particle size of the lithium iron phosphate is denoted as A nm, an average particle size of the conductive agent is denoted as B nm, and a ratio of A to B is (2-60):1.

5. The positive electrode plate according to claim 4, wherein a ratio of A to B is (2.5-8):1;
and/or, the primary particle size A of the lithium iron phosphate is 100 nm-600 nm;
and/or, the average particle size B of the conductive agent is 10 nm-100 nm.

6. The positive electrode plate according to claim 4, wherein the primary particle size A of the lithium iron phosphate is 140 nm-300 nm;
and/or, the average particle size B of the conductive agent is 40 nm-70 nm.

7. The positive electrode plate according to claim 4, wherein a surface resistivity of the positive electrode plate is denoted as R Ω·cm; the relationship between the primary particle size A of the lithium iron phosphate and the surface resistivity R of the positive electrode plate satisfies: 0.18≤A/R≤3.

8. The positive electrode plate according to claim 7, wherein the surface resistivity R of the positive electrode plate is 200 Ω·cm-600 Ω·cm.

9. The positive electrode plate according to claim 1, wherein the positive electrode plate further comprises a binder; a mass ratio of the conductive agent to the binder is 1:(0.3-2).

10. The positive electrode plate according to claim 9, wherein the mass ratio of the conductive agent to the binder is 1:(0.4-1.6).

11. The positive electrode plate according to claim 9, wherein in the positive electrode plate, a mass proportion of the binder is 2%-5%;
and/or, a peeling strength of the positive electrode plate is 4 gf/mm-25 gf/mm.

12. The positive electrode plate according to claim 9, wherein the binder comprises at least one of polyvinylidene fluoride, polytetrafluoroethylene, polyoxyethylene, sodium carboxymethyl cellulose, or styrene-butadiene rubber.

13. The positive electrode plate according to claim 1, wherein a press density of the positive electrode plate is 1.8 g/cm³-2.5 g/cm³;
and/or, a specific surface area C of the lithium iron phosphate is 8 m²/g-15 m²/g;
and/or, the conductive agent comprises at least one of conductive carbon black, conductive graphite, acetylene black, Keqin black, graphene, conductive carbon fiber, carbon nanotube, metal powder, or carbon fiber.

14. A battery, wherein the battery comprises the positive electrode plate according to claim 1.

15. The battery according to claim 14, wherein the battery comprises a separator; the separator comprises a base film and an adhesive layer disposed on at least one side surface of the base film; and
a projected area proportion of the adhesive layer on the base film is denoted as S, the primary particle size of the lithium iron phosphate is denoted as A nm, and the relationship between S and A satisfies: 0.03≤S/A≤0.35.

16. The battery according to claim 15, wherein the relationship between S and A satisfies: 0.1≤S/A≤0.25;
and/or, the projected area proportion S of the adhesive layer on the base film is 15%-35%.

17. The battery according to claim 14, wherein the specific surface area of the lithium iron phosphate is denoted as C m²/g, a thermal shrinkage rate of the separator is denoted as L %, the relationship between C and L satisfies: 0.16≤C/L≤0.75.

18. The battery according to claim 17, wherein the specific surface area C of the lithium iron phosphate is 8 m²/g-15 m²/g;
and/or, the thermal shrinkage rate L of the separator is 20%-50%.

19. The battery according to claim 14, wherein the battery further comprises a negative electrode plate, the negative electrode plate comprises a negative active material; and
the negative active material comprises at least one of graphite, hard carbon, mesocarbon microbead, silicon carbide, silicon oxide, nano-silicon, or silicon alloy.

20. The battery according to claim 19, wherein the negative active material comprises graphite and hard carbon; and
in the negative active material, a proportion of hard carbon is 0 wt %-30 wt %, and a proportion of graphite is 70 wt %-100 wt %.
